(19) United States
(12) Patent Application Publication
(10) Pub. No.: US 2007/0140465 A1
(43) Pub. Date: Jun. 21, 2007

(54) Dynamic content stream delivery to a telecommunications terminal based on the excecution state of the terminal

(75) Inventors: George William Erhart, Loveland, CO (US); Valentine C. Matula, Granville, OH (US); David Joseph Skiba, Golden, CO (US)

Correspondence Address: DEMONT & BREYER, LLC, 100 COMMONS WAY, STE 250, HOLMDEL, NJ, 07733, US

(73) Assignee: Avaya Technology LLC, Basking Ridge, NJ (US)

(21) Appl. No.: 11/303,820

(22) Filed: Dec. 16, 2005

(51) Int. Cl. H04M 7/00

(52) U.S. Cl. 379/235

(57) ABSTRACT

A method and apparatus are disclosed for delivering a content stream to a terminal only when the terminal has a transducer (e.g., speaker, video display, etc.) that is (i) capable of outputting the content stream's media type, and (ii) there are no software applications running at the terminal that use the transducer. For example, if a terminal has both a speaker and a video display, and the terminal is running an application that sends output to the video display, an audio stream, but not a video stream, is delivered to the terminal. The illustrative embodiment is disclosed in the context of an interactive voice response system, but is applicable in a wide variety of other telecommunications systems and applications.

### FIELD OF THE INVENTION

The present invention relates to telecommunications in general, and, more particularly, to the delivery of one or more content streams to a telecommunications terminal based on the execution state of the terminal.

### BACKGROUND OF THE INVENTION

Many enterprises employ an interactive voice response (IVR) system that handles calls from telecommunications terminals. An interactive voice response system typically presents a hierarchy of menus to the caller, and prompts the caller for input to navigate the menus and to supply information to the IVR system. For example, a caller might touch the “3” key of his terminal's keypad, or say the word “three”, to choose the third option in a menu. Similarly, a caller might specify his bank account number to the interactive voice response system by inputting the digits via the keypad, or by saying the digits. In many interactive voice response systems the caller can connect to a person in the enterprise by either selecting an appropriate menu option, or by entering the telephone extension associated with that person.

FIG. 1 depicts telecommunications system 100 in accordance with the prior art. Telecommunications system 100 comprises telecommunications terminal 101, telecommunications network 105, private branch exchange (PBX) 110, and interactive voice response system 120, interconnected as shown.

Telecommunications terminal 101 is one of a telephone, a notebook computer, a personal digital assistant (PDA), etc. and is capable of placing and receiving calls via telecommunications network 105.

Telecommunications network 105 is a network such as the Public Switched Telephone Network [PSTN], the Internet, etc. that carries calls to and from telecommunications terminal 101, private branch exchange 110, and other devices not show in FIG. 1. A call might be a conventional voice telephony call, a text-based instant messaging (IM) session, a Voice over Internet Protocol (VoIP) call, etc.

Private branch exchange (PBX) 110 receives incoming calls from telecommunications network 105 and directs the calls to interactive voice response (IVR) system 120 or to one of a plurality of telecommunications terminals within the enterprise, depending on how private branch exchange 110 is programmed or configured. For example, in an enterprise call center, private branch exchange 110 might comprise logic for routing calls to service agents' terminals based on criteria such as how busy various service agents have been in a recent time interval, the telephone number called, and so forth. In addition, private branch exchange 110 might be programmed or configured so that an incoming call is initially routed to interactive voice response (IVR) system 120, and, based on caller input to IVR system 120, subsequently redirected back to PBX 110 for routing to an appropriate telecommunications terminal within the enterprise. Private branch exchange (PBX) 110 also receives outbound signals from telecommunications terminals within the enterprise and from interactive voice response (IVR) system 120, and transmits the signals on to telecommunications network 105 for delivery to a caller's terminal.

Interactive voice response (IVR) system 120 is a data-processing system that presents one or more menus to a caller and receives caller input (e.g., speech signals, keypad input, etc.), as described above, via private branch exchange 110. Interactive voice response system (IVR) 120 is typically programmable and performs its tasks by executing one or more instances of an IVR system application. An IVR system application typically comprises one or more scripts that specify what speech is generated by interactive voice response system 120, what input to collect from the caller, and what actions to take in response to caller input. For example, an IVR system application might comprise a top-level script that presents a main menu to the caller, and additional scripts that correspond to each of the menu options (e.g., a script for reviewing bank account balances, a script for making a transfer of funds between accounts, etc.).

A popular language for such scripts is the Voice extensible Markup Language (abbreviated VoiceXML or VXML). The Voice extensible Markup Language is an application of the extensible Markup Language, abbreviated XML, which enables the creation of customized tags for defining, transmitting, validating, and interpretation of data between two applications, organizations, etc. The Voice extensible Markup Language enables dialogs that feature synthesized speech, digitized audio, recognition of spoken and keyed input, recording of spoken input, and telephony. A primary objective of VXML is to bring the advantages of web-based development and content delivery to interactive voice response system applications.

FIG. 2 depicts an exemplary Voice extensible Markup Language (VXML) script (also known as a VXML document or page), in accordance with the prior art. The VXML script, when executed by interactive voice response system 120, presents a menu with three options; the first option is for transferring the call to the sales department, the second option is for transferring the call to the marketing department, and the third option is for transferring the call to the customer support department. Audio content (in particular, synthesized speech) that corresponds to text between the <prompt> and </prompt> tags is generated by interactive voice response system 120 and transmitted to the caller.

### SUMMARY OF THE INVENTION

As video displays become ubiquitous in telecommunications terminals, it can be advantageous to deliver video content to a telecommunications terminal during a call with an interactive voice response (IVR) system, in addition to audio content. For example, a user of a telecommunications terminal who is ordering apparel via an IVR system might receive a video content stream related to a particular item (e.g., depicting a model who is wearing the item, depicting the different available colors for the item, etc.). Furthermore, in some instances it might be desirable to deliver an audio content stream (e.g., music, news, etc.) to the user, perhaps during silent periods in the call, or perhaps as background audio throughout the entire call.

The illustrative embodiment of the present invention enables an IVR system to deliver content streams of various media types (e.g., video, audio, etc.) to telecommunications terminals via the addition of extensions to the Voice extensible Markup Language (VXML) standard. Furthermore, in accordance with the illustrative embodiment, an interactive voice response (IVR) system will deliver a particular content stream to a terminal only if: (i) the terminal has a transducer (e.g., speaker, video display, etc.) that is capable of outputting the content stream's media type, and (ii) there are no software applications running at the terminal that use the transducer. For example, if a terminal has both a speaker and a video display, and the terminal is running an application that sends output to the video display, the interactive voice response system might deliver an audio stream, but not a video stream, to the terminal.

In accordance with the illustrative embodiment, a telecommunications terminal notifies the interactive voice response system of the execution state of the terminal at the beginning of a call, and if necessary, notifies the interactive voice response system of changes in execution state during the call. Execution state includes such information as what applications are running, what outputs are generated by the executing applications, which transducers of the terminal receive output from executing applications, as well as information that might not be pertinent to the present invention (e.g., virtual memory usage, etc.).

If a script of the interactive voice response system contains a command to deliver a content stream to the telecommunications terminal, and an appropriate transducer of the terminal is not available for outputting the content, the interactive voice response system will not deliver the content stream. Similarly, if an IVR system script contains a command to deliver a group of two or more content streams, the interactive voice response system will deliver only those streams in the group, if any, for which the terminal has an available transducer.

In accordance with the illustrative embodiment, if, while a content stream is being delivered to a terminal, the interactive voice response system receives a signal that indicates that a new application has been started at the terminal that uses the transducer that is currently outputting the content stream, then the interactive voice response system stops transmitting the content stream. In addition, if the new application is subsequently terminated during the call, then the interactive voice response system either (i) resumes transmission of the stopped content stream (i.e., begins transmitting the stream at the point at which playback was stopped) or (ii) re-starts transmission of the stopped content stream from the beginning. Whether a stopped content stream is resumed or re-started can be based on factors such as: an implementation choice, a system administrator's preferences, a caller's preferences, the-nature of a particular content stream (e.g., real-time versus pre-recorded, etc.), and so forth.

The illustrative embodiment comprises: transmitting a signal of media type T to a telecommunications terminal only when: (i) the telecommunications terminal has a transducer whose output is of the media type T, and (ii) no applications are currently executing at the telecommunications terminal that use the transducer to generate an output signal.

### BRIEF DESCRIPTION OF THE DRAWINGS

FIG. 1 depicts telecommunications system 100 in accordance with the prior art.

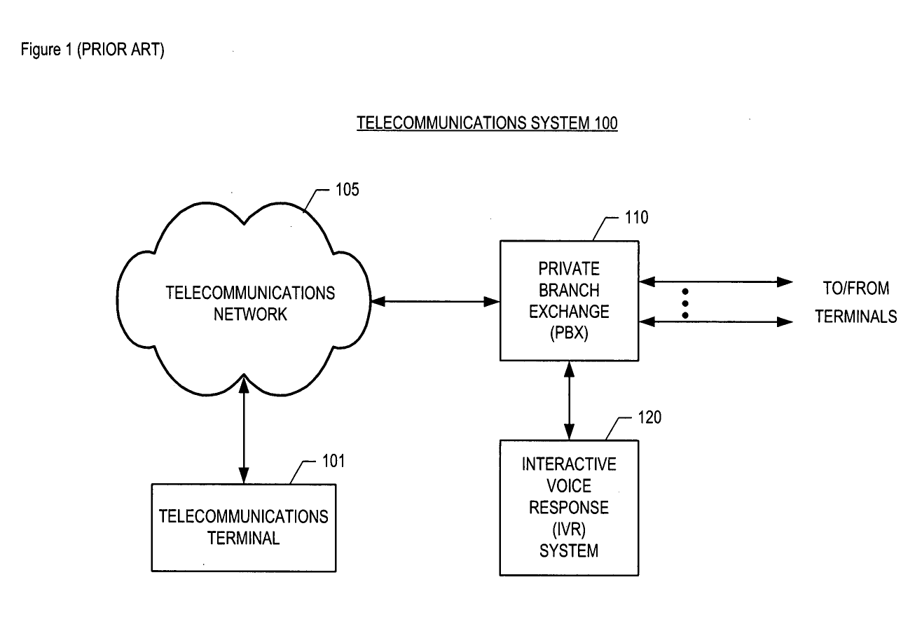

FIG. 2 depicts an exemplary Voice extensible Markup Language (VXML) script, in accordance with the prior art.

FIG. 3 depicts telecommunications system 300 in accordance with the illustrative embodiment of the present invention.

FIG. 4 depicts an exemplary Voice extensible Markup Language (VXML) script, in accordance with the illustrative embodiment of the present invention.

FIG. 5 depicts a flowchart of the salient tasks of interactive voice response system 320, as shown in FIG. 3, in accordance with the illustrative embodiment of the present invention.

FIG. 6 depicts a flowchart of the salient tasks of a thread that is spawned at task 560 of FIG. 5, in accordance with the illustrative embodiment of the present invention.

FIG. 7 depicts a detailed flowchart of task 630, as shown in FIG. 6, in accordance with the illustrative embodiment of the present invention.

FIG. 8 depicts a detailed flowchart of task 640, as shown in FIG. 6, in accordance with the illustrative embodiment of the present invention.

FIG. 9 depicts a flowchart of the salient tasks of telecommunications terminal 301, as shown in FIG. 3, during a call with interactive voice response system 320, in accordance with the illustrative embodiment of the present invention.

### DETAILED DESCRIPTION

The terms appearing below are given the following definitions for use in this Description and the appended Claims.

For the purposes of the specification and claims, the term “call” is defined as an interactive communication involving one or more telecommunications terminal users. A call might be a traditional voice telephone call, an instant messaging (IM) session, a video conference, etc.

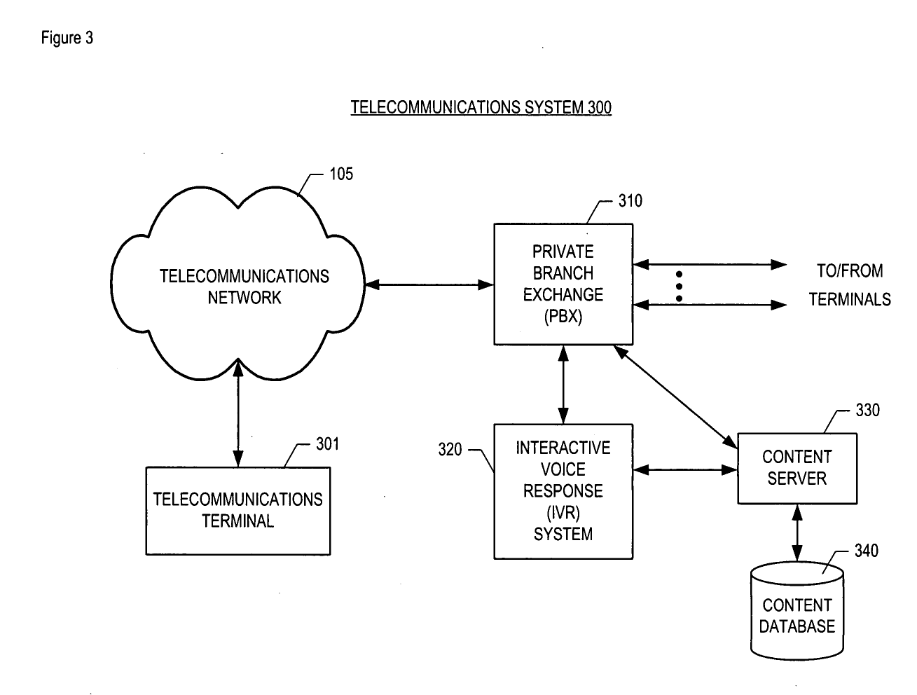

FIG. 3 depicts telecommunications system 300 in accordance with the illustrative embodiment of the present invention. Telecommunications system 300 comprises telecommunications terminal 301, telecommunications network 105, private branch exchange (PBX) 310, interactive voice response system 320, content server 330, and content database 340, interconnected as shown.

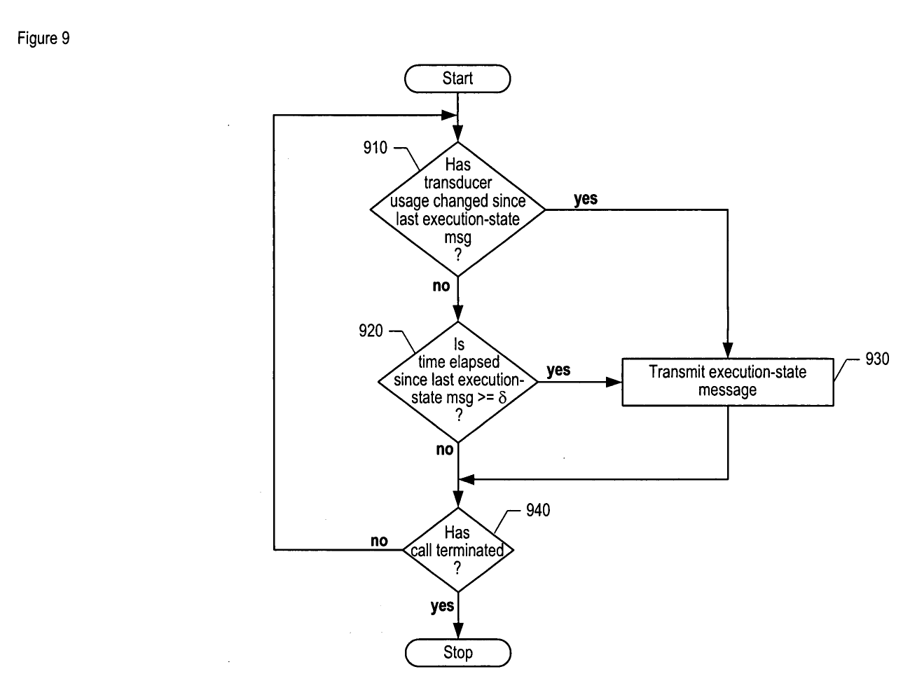

Telecommunications terminal 301 is one of a telephone, a notebook computer, a personal digital assistant (PDA), etc. and is capable of placing and receiving calls via telecommunications network 305. Telecommunications terminal 301 also has one or more transducers (e.g., a speaker, a video display, etc.) for outputting signals that are received via telecommunications network 105, in well-known fashion. In addition, telecommunications terminal 301 is capable of performing the tasks of FIG. 9, described below.

Private branch exchange (PBX) 310 provides all the functionality of private branch exchange (PBX) 110 of the prior art, and is also capable of receiving streamed content (e.g., audio, video, multimedia, etc.) from content server 330, of forwarding streamed content on to telecommunications network 105 for delivery to a caller's terminal, and of transmitting signals related to streamed content to content server 330. Furthermore, in addition to conventional telephony-based signaling and voice signals, private branch exchange 310 is also capable of transmitting and receiving Internet Protocol (IP) data packets, Session Initiation Protocol (SIP) messages, Voice over IP (VoIP) traffic, and stream-related messages (e.g., Real Time Streaming Protocol [RTSP] messages, etc.) to and from IVR system 320. It will be clear to those skilled in the art, after reading this specification, how to make and use private branch exchange (PBX) 310.

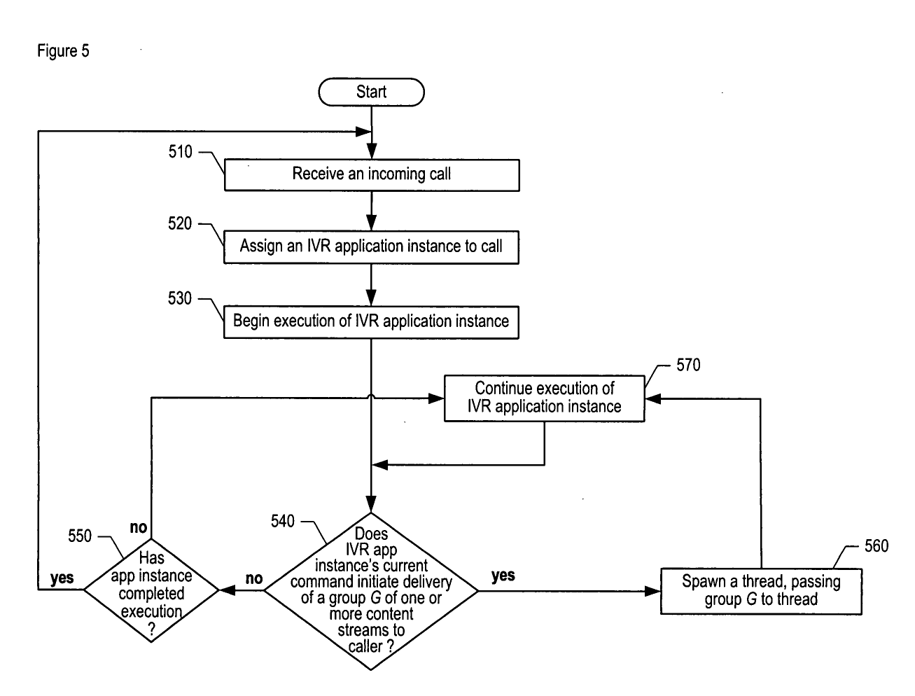

Interactive voice response system 320 provides all the functionality of interactive voice response system 120 of the prior art, and is also capable of transmitting commands to content server 330 (e.g., starting playback of a content stream, stopping playback of the content stream, queueing another content stream, etc.) and of receiving information from content server 330 (e.g., an indication that playback of a content stream has begun, an indication that playback of a content stream has completed, etc.). In addition, interactive voice response system 320 is capable of performing the tasks of FIGS. 5 through 9, described below. It will be clear to those skilled in the art, after reading this specification, how to make and use interactive voice response system 320.

Content server 330 is capable of retrieving content from content database 340, of buffering and delivering a content stream to a calling terminal via private branch exchange 310, of receiving commands from interactive voice response system 320 (e.g., to start playback of a content stream, to queue another content stream, etc.), of transmitting status information to interactive voice response system 320, and of generating content (e.g., dynamically generating a video of rendered text, etc.) in well-known fashion. It will be clear to those skilled in the art, after reading this specification, how to make and use content server 330.

Content database 340 is capable of storing a plurality of multimedia content (e.g., video content, audio content, etc.) and of retrieving content in response to commands from content server 330, in well-known fashion. It will be clear to those skilled in the art, after reading this specification, how to make and use content database 340.

As will be appreciated by those skilled in the art, some embodiments of the present invention might employ an architecture for telecommunications system 300 that is different than that of the illustrative embodiment (e.g., interactive voice response system 320 and content server 330 might reside on a common server, etc.). It will be clear to those skilled in the art, after reading this specification, how to make and use such alternative architectures.

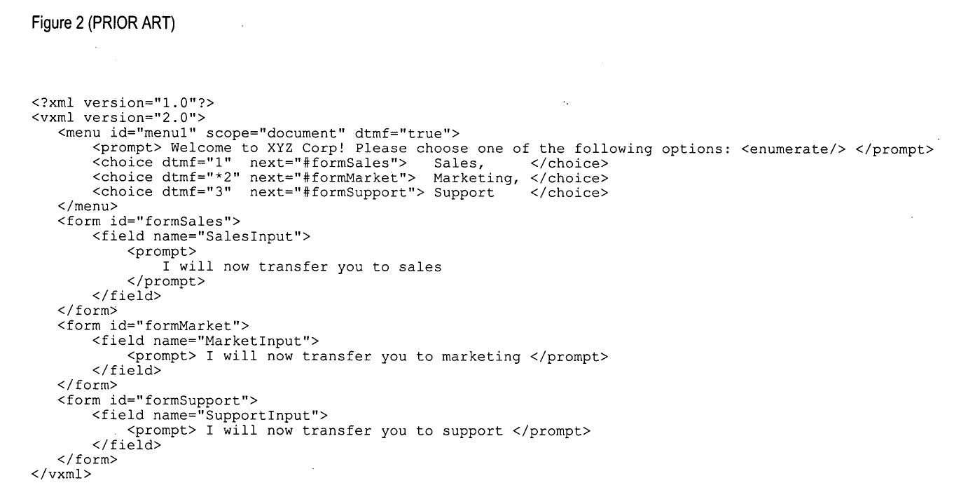

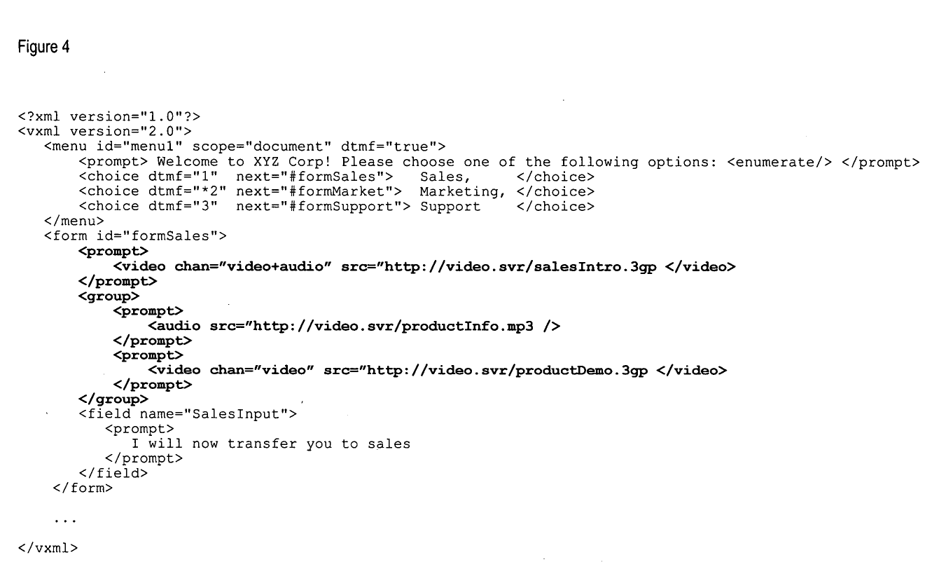

FIG. 4 depicts an exemplary Voice Extensible Markup Language (VXML) script, in accordance with the illustrative embodiment of the present invention. The script is the same as the script of FIG. 2 of the prior art, with the addition of lines of code depicted in boldface. As shown in FIG. 4, the script now contains prompts that are audio and video content streams, in addition to speech prompts.

In accordance with the script of FIG. 4 of the illustrative embodiment, when a user selects choice 1 (sales), interactive voice response system 320 delivers one, both, or neither of the audio and video portions of stream salesIntro.3gp based on whether telecommunications terminal 301 has an available speaker and/or an available video display.

In some embodiments of the present invention, a transducer (e.g., speaker, video display, etc.) might be considered to be available if no applications that are running at terminal 301 send output to the transducer. For example, a software application at telecommunications terminal 301 that (silently) displays an animated stock market ticker tape would render the terminal's video display unavailable but would leave the terminal's speaker available.

As will be appreciated by those skilled in the art, some telecommunications terminals might have a plurality of video displays, or might have a single video display that is sufficiently large to accommodate a plurality of “virtual video displays” (e.g., windows, etc.). For such terminals, a video display that is not used by any applications, whether a real display or a virtual display, could be considered available. Similarly, a terminal might be considered to have an available display if the terminal has the capability, and sufficient screen “real estate”, to dynamically add a virtual display without hiding or severely shrinking the video output of impacting executing applications.

As another example, a software application at telecommunications terminal 301 that plays audio files (e.g., MP3, WAV, etc.) would render the terminal's speaker unavailable but would leave the terminal's video display available. As will be appreciated by those skilled in the art, it might be possible, but is typically undesirable, to output concurrently a plurality of audio streams, whether from a single speaker or a plurality of speakers.

In some other embodiments of the present invention, a transducer might be considered to be available if no applications that are running at terminal 301 send a primary output to the transducer. For example, a video game such as Tetris® could be considered to have a primary (i.e., essential) video output, and a secondary (i.e., non-essential or “non-primary”) audio output, because it is possible for a user to play the video game with video only. As another example, an application that plays audio files might also display a graphical representation of the audio files, in which case audio is a primary output and video is a secondary output.

In accordance with the illustrative embodiment, a VXML script can also have a <group> block that comprises a plurality of content streams of different media types. For example, the script of FIG. 4 has a <group> block that comprises an audio content stream productInfo.mp3 and a video content stream productDemo.3gp. When processing this <group> block, interactive voice response system 320 will deliver one, both, or neither of audio content stream productInfo.mp3 and video content stream productDemo.3gp based on whether there is an available speaker and/or an available video display at the telecommunications terminal, as indicated by the current execution state of the terminal. The particular tasks that are performed by interactive voice response system 320 in order to process a <group> block in this manner are described below and with respect to FIGS. 5 through 9.

As will be appreciated by those skilled in the art, in some other embodiments of the present invention, a tag or programming language construct other than a <group> block might be employed to organize multiple content streams.

FIG. 5 depicts a flowchart of the salient tasks of interactive voice response system 320, in accordance with the illustrative embodiment of the present invention. It will be clear to those skilled in the art which tasks depicted in FIG. 5 can be performed simultaneously or in a different order than that depicted.

At task 510, an incoming call is received at interactive voice response system 320, in well-known fashion.

At task 520, interactive voice response system 320 assigns an instance of an appropriate IVR system application to the incoming call, in well-known fashion. As will be appreciated by those skilled in the art, although in the illustrative embodiment an instance of an IVR system application handles one incoming call at a time, in some other embodiments of the present invention an application instance might handle a plurality of calls concurrently.

At task 530, interactive voice response system 320 begins executing the IVR application instance, in well-known fashion.

At task 540, interactive voice response system 320 checks whether the current command to be executed in the IVR application instance initiates delivery of a group G of one or more content streams to the calling telecommunications terminal. A group that comprises multiple content streams might be specified explicitly by a <group> block, or implicitly via a single prompt (e.g., the audio and video streams of a 3gp file, etc.), while a group that comprises a single content stream will typically be specified by a single prompt (e.g., an audio prompt, a video prompt in which chan=“video”, etc.). If the current command initiates delivery of a group G of one or more content streams, execution continues at task 560, otherwise, execution proceeds to task 550.

At task 550, interactive voice response system 320 checks whether the IVR application instance's execution has completed. If so, execution continues back at task 510 for the next incoming call; otherwise, execution proceeds to task 590.

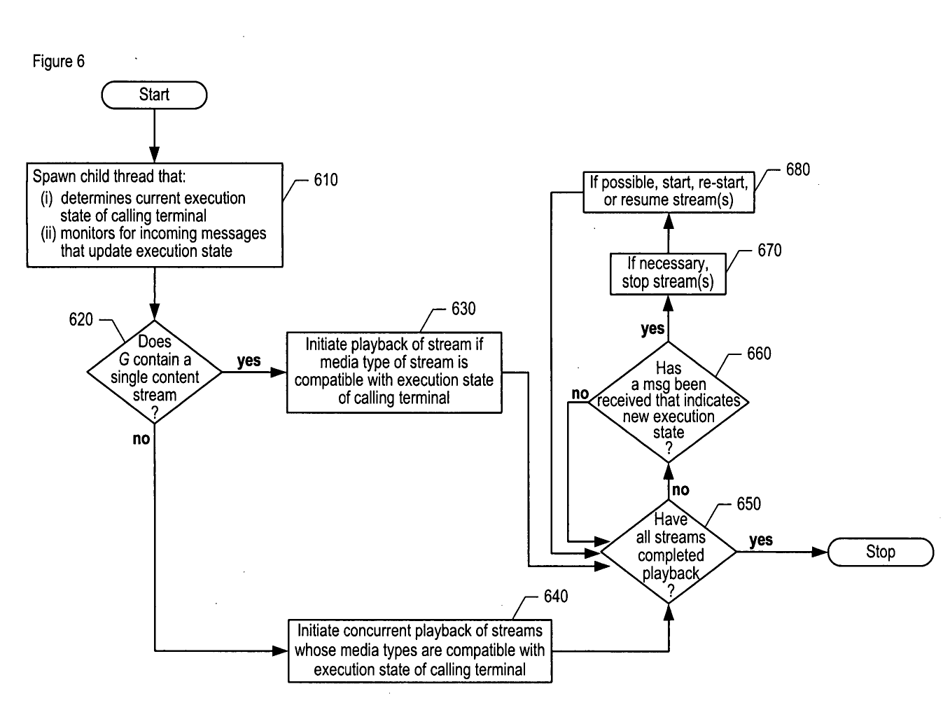

At task 560, interactive voice response system 320 spawns a thread that is responsible for starting and stopping the delivery of content streams to the calling terminal during the call. Group G is passed to the thread, in well-known fashion (e.g., via a memory pointer, via an operating system inter-thread communication mechanism, etc.). The operation of this thread is described in detail below and with respect to FIGS. 6 through 9.

At task 570, interactive voice response system 320 continues the execution of the IVR application instance, in well-known fashion. After task 570, execution continues back at task 540.

FIG. 6 depicts a flowchart of the salient tasks of the thread spawned at task 560, in accordance with the illustrative embodiment of the present invention. It will be clear to those skilled in the art which tasks depicted in FIG. 6 can be performed simultaneously or in a different order than that depicted.

At task 610, the thread spawns a child thread that: (i) determines the current execution state of the calling terminal and (ii) monitors during the call for incoming messages that update the execution state. In accordance with the illustrative embodiment, the execution state includes information such as what applications are running at the calling terminal, what outputs are generated by these executing applications, which transducers of the calling terminal receive output from these executing applications, as well as information that might not be pertinent to the present invention (e.g., virtual memory usage, etc.). The child thread performs subtask (i) once at startup, and performs subtask (ii) continually during the call. The child thread dies when the (parent) thread dies (i.e., after the determination of task 650, described below, is affirmative).

At task 620, the thread checks whether group G contains a single content stream S. If so, execution proceeds to task 630, otherwise execution continues at task 640.

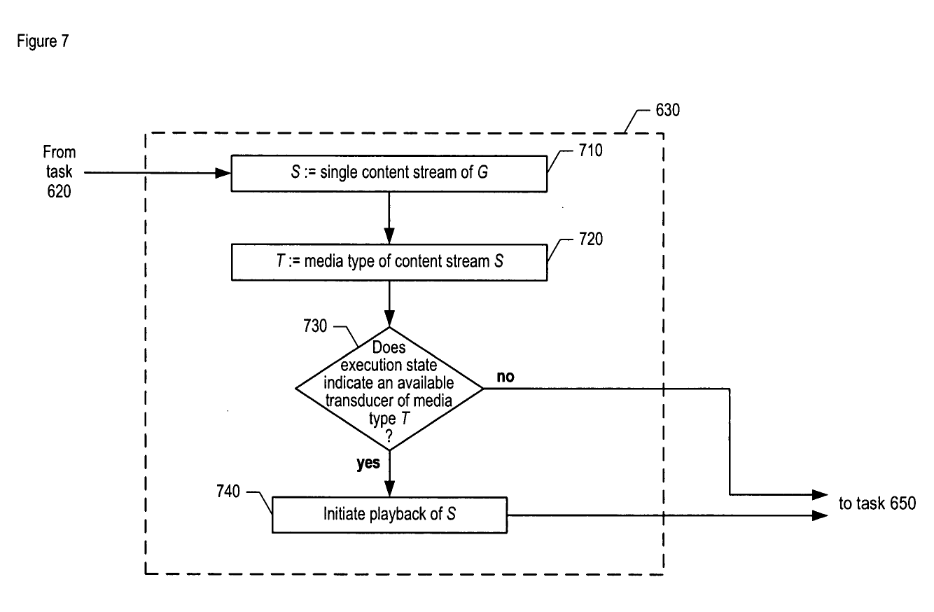

At task 630, the thread initiates playback of the single content stream S if its media type is compatible with the execution state of the calling terminal (i.e., if the calling terminal has an available transducer for that media type). Task 630 is described in detail below and with respect to FIG. 7.

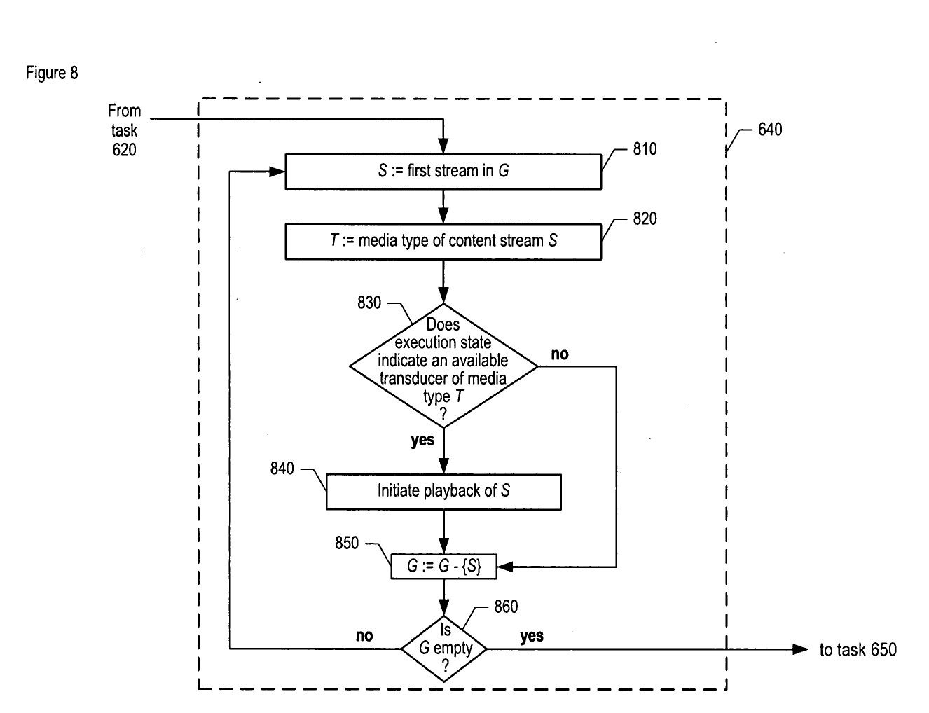

At task 640, the thread initiates concurrent playback of as many of the content streams of group G as possible, as described in detail below and with respect to FIG. 8.

At task 650, the thread checks whether playback of all content streams has completed. If so, the thread and its child (spawned at task 610) die, otherwise execution continues at task 660.

At task 660, the thread checks whether a message that updates the execution state of the calling terminal has been received. If not, execution continues back at task 650, otherwise execution proceeds to task 670.

At task 670, the thread stops, if necessary, one or more of the content streams that are being delivered to the calling terminal, based on an indication that one or more transducers of the calling terminal are newly-unavailable as a result of one or more new applications initiated at the calling terminal.

At task 680, the thread, if possible, starts playback of one or more new content streams, or resumes/re-starts playback of one or more stopped content streams, or both, based on an indication that one or more transducers of the calling terminal are newly-available as a result of the halting or termination of one or more executing applications at the calling terminal. After task 680, execution of the thread continues back at task 650.

FIG. 7 depicts a detailed flowchart of task 630, in accordance with the illustrative embodiment of the present invention. It will be clear to those skilled in the art which subtasks depicted in FIG. 7 can be performed simultaneously or in a different order than that depicted.

At subtask 710, the thread initializes variable S to the single content stream of group G.

At subtask 720, the thread initializes variable T to the media type of content stream S.

At subtask 730, the thread checks whether the execution state of the calling terminal indicates that there is an available transducer of media type T. If so, execution continues at subtask 740, otherwise execution continues at task 650 of FIG. 6.

At subtask 740, the thread initiates playback of content stream S, in well-known fashion. After subtask 740, execution continues at task 650 of FIG. 6.

FIG. 8 depicts a detailed flowchart of task 650, in accordance with the illustrative embodiment of the present invention. It will be clear to those skilled in the art which subtasks depicted in FIG. 8 can be performed simultaneously or in a different order than that depicted.

At subtask 810, the thread sets variable S to the first content stream in group G.

At subtask 820, the thread sets variable T to the media type of content stream S.

At subtask 830, the thread checks whether the execution state of the calling terminal indicates that there is an available transducer of media type T. If so, execution continues at subtask 840, otherwise execution continues at subtask 850.

At subtask 840, the thread initiates playback of content stream S, in well-known fashion.

At subtask 850, the thread removes content stream S from group G.

At subtask 860, the thread checks whether G is empty. If not, execution continues back at subtask 810, otherwise execution continues at task 650 of FIG. 6.

FIG. 9 depicts a flowchart of the salient tasks of telecommunications terminal 301 during a call with interactive voice response system 320, in accordance with the illustrative embodiment of the present invention.

At task 910, telecommunications terminal 301 checks whether its transducer usage has changed since its last execution-state message. If so, execution proceeds to task 930, otherwise execution continues at task 920.

At task 920, telecommunications terminal 301 checks whether at least δ seconds have elapsed since sending the last execution-state message. (As will be appreciated by those skilled in the art, although it might not be necessary to send an execution-state message when nothing material has changed, it is often good practice to transmit such “heartbeat” messages periodically.) If at least δ seconds have elapsed since the last execution-state message, execution proceeds to task 930, otherwise execution continues at task 940.

At task 930, telecommunications terminal 301 transmits a message to interactive voice response system 320 that specifies the current execution state of the terminal. In the illustrative embodiment, this message is transmitted in accordance with the Session Initiation Protocol (SIP). It will be clear to those skilled in the art how to send this information via some other protocol or signal.

At task 940, telecommunications terminal 301 checks whether the call has terminated. If so, the method of FIG. 9 terminates, otherwise execution continues back at task 910.

As will be appreciated by those skilled in the art, in some embodiments of the present invention it might be advantageous for telecommunications network 105 to be aware of changes in the execution, state of telecommunications terminal 301 when the terminal is not involved in a call with interactive voice response system 320 (e.g., during a call with another terminal, between calls, etc.) Such embodiments could enable other applications of telecommunications network 105 that are independent of interactive voice response system 320 to make use of this information. As will be appreciated by those skilled in the art, in such embodiments the method of FIG. 9 should be modified so that it executes at times other than just during calls with interactive voice response system 320. As will be further appreciated by those skilled in the art, in such embodiments one or more terminals or elements of telecommunications network 105's infrastructure (e.g., a switch, etc.) might be reprogrammed to monitor and receive messages that are transmitted by terminal 301 in accordance with the method of FIG. 9, as is done by the child thread spawned at task 610 at interactive voice response system 320.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising transmitting a signal of media type T to a telecommunications terminal only when:
(i) said telecommunications terminal has a transducer whose output is of said media type T, and
(ii) no applications are currently executing at said telecommunications terminal that use said transducer to generate an output signal.

2. The method of claim 1 wherein the transmitting is during a call that involves said telecommunications terminal.

3. The method of claim 2 wherein the transmitting is effected by an interactive voice response system that is involved in said call.

4. A method comprising transmitting a signal of media type T to a telecommunications terminal only when:
(i) said telecommunications terminal has a transducer whose output is of said media type T, and
(ii) no applications are currently executing at said telecommunications terminal that use said transducer to generate a primary output signal.

5. The method of claim 4 wherein the transmitting is during a call that involves said telecommunications terminal.

6. The method of claim 4 wherein the transmitting is effected by an interactive voice response system that is involved in said call.

7. A method comprising stopping the transmission of a signal of media type T to a telecommunications terminal during a call that involves said telecommunications terminal when an application is started at said telecommunications terminal that generates an output signal of said media type T.

8. The method of claim 7 further comprising re-starting the transmission of said signal when said application is terminated.

9. The method of claim 7 further comprising resuming the transmission of said signal when said application is terminated.

10. The method of claim 7 wherein the stopping of the transmission of said signal is effected by an interactive voice response system that is involved in said call.

11. A method comprising transmitting a first signal from a telecommunications terminal when an application that generates an output signal of media type T is started at said telecommunications terminal, wherein said first signal is for notifying at least one of:
(i) a network infrastructure element,
(ii) another telecommunications terminal, and
(iii) an interactive voice response system
that there is no available transducer at said telecommunications terminal for outputting said media type T.

12. The method of claim 10 wherein said application is started during a call that involves said telecommunications terminal, and wherein the transmitting of said first signal occurs during said call.

13. The method of claim 12 wherein said telecommunications terminal is receiving a second signal of said media type T when said application is started.

14. The method of claim 13 wherein said first signal is also for stopping transmission of said second signal to said telecommunications terminal.

15. A method comprising transmitting a first signal from a telecommunications terminal when an application that generates an output signal of media type T is terminated at said telecommunications terminal, wherein said first signal is for notifying at least one of:
(i) a network infrastructure element,
(ii) another telecommunications terminal, and
(iii) an interactive voice response system
that there is a newly-available transducer at said telecommunications terminal for outputting said media type T.

16. The method of claim 15 wherein said application is terminated during a call that involves said telecommunications terminal, and wherein the transmitting of said first signal occurs during said call.

17. The method of claim 16 wherein said first signal is also for re-starting transmission of a second signal of said media type T to said telecommunications terminal.

18. The method of claim 17 further comprising receiving said second signal at said telecommunications terminal in response to the transmitting of said first signal.

19. The method of claim 16 wherein said first signal is also for resuming transmission of a second signal of said media type T to said telecommunications terminal.

20. The method of claim 19 further comprising receiving said second signal at said telecommunications terminal in response to the transmitting of said first signal.
